(19) United States
(12) Patent Application Publication
(10) Pub. No.: US 2018/0165041 A1
(43) Pub. Date: Jun. 14, 2018

(54) ORDER RECEIVING SYSTEM AND PRINTER

(71) Applicant: SEIKO EPSON CORPORATION, Tokyo (JP)

(72) Inventors: Koji HASHIMOTO, Matsumoto-shi (JP); Dai TANAKA, Matsumoto-shi (JP); Keigo MORI, Matsumoto-shi (JP); Yoshinori OSHIMA, Matsumoto-shi (JP)

(21) Appl. No.: 15/824,011

(22) Filed: Nov. 28, 2017

(30) Foreign Application Priority Data
Dec. 9, 2016 (JP) 2016-239104

(51) Int. Cl. G06F 3/12; G06F 21/44; G06F 21/60

(52) U.S. Cl. CPC G06F 3/1204; G06F 21/44; G06Q 2220/165; G06F 3/1222; G06F 21/608

(57) ABSTRACT

An order receiving system includes a server that provides a terminal device owned by a customer with an ordering application, and a printer that prints details of an order entered via the ordering application. The server includes a memory unit that has an area for storing the ordering application, a first receiver that receives entry of the order from the customer via the ordering application, and a first transmitter that transmits to the terminal device an email form addressed to the printer. A token for permitting access from the printer is attached to the email form. The printer includes a second receiver that receives an email from the terminal device, a second transmitter that transmits to the server an authentication request for the token attached to the received email, and a printing unit that prints the details of the order based on authentication of the token by the server.

### BACKGROUND

### 1. Technical Field

The present invention relates to an order receiving system and a printer.

### 2. Related Art

A system in which a customer at a retail establishment such as a restaurant enters an order into a terminal device prepared for customers, and the order is then received by a management apparatus installed in the retail establishment is known (see, for example, Japanese Patent No. 3,505,492).

In the system described in the aforementioned Japanese Patent No. 3,505,492, a terminal device specifically for ordering needs to be prepared for customers. If terminal devices owned by customers can be used in such a system, this will reduce the cost of introducing the system and also increase the convenience of retail establishments and customers.

### SUMMARY

An advantage of some aspects of the invention is to increase the convenience of an order receiving system.

Some aspects of the invention can be implemented as the following forms or application examples.

### APPLICATION EXAMPLE 1

An order receiving system includes a server that provides a terminal device owned by a customer with an ordering application, which is for receiving entry of an order, in response to a request from the customer, and a printer that prints details of the order entered via the ordering application provided to the terminal device. The server includes a memory unit that has an area for storing the ordering application, a first receiver that receives the entry of the order from the customer via the ordering application, a token generator that generates a token for permitting access from the printer, and a first transmitter that transmits to the terminal device an email form addressed to the printer in a state in which the token is attached to the email form. The printer includes a second receiver that receives an email (based on the email form) from the terminal device, a second transmitter that transmits to the server an authentication request for the token attached to the email received by the second receiver, and a printing unit that prints the details of the order based on authentication of the token by the server.

In this order receiving system, the server receives the order entered (via the ordering application) from the terminal device owned by the customer at a retail establishment. By accessing the server, the printer located in the retail establishment can print the details of the order. Access to the server from the printer can be achieved by the process described below. The customer (the terminal device) who entered the order transmits to the printer the email, which is based on the email form received from the server, with the attached token. After receiving the email with the attached token, the printer transmits the authentication request for the token to the server. When the server receives the authentication request for the token from the printer and authenticates the token, access to the server from the printer is permitted, and the printer prints the details of the order from the customer. As a result, the order from the customer is accepted. Since such an order receiving system can use the terminal device owned by the customer, convenience of order receiving systems may be improved by using the order receiving system.

### APPLICATION EXAMPLE 2

In the above-described order receiving system, the token is valid for a one-time entry of the order from the customer received by the server and also has a period of validity.

In this order receiving system, since the token is valid for a one-time entry of the order and has a period of validity, repeated use of the single token, use of the token beyond the period of validity, and the like may be prevented.

### APPLICATION EXAMPLE 3

In the above-described order receiving system, the server further includes a determination unit that determines in accordance with location information, which is transmitted from the terminal device and received by the first receiver, whether the entry of the order received by the first receiver is valid.

In this order receiving system, whether the order is valid can be determined in accordance with the location of the customer (the terminal device) who entered the order, and only the valid order can be accepted. For example, in a case in which the customer who entered the order is inside the retail establishment, the order is accepted as a valid order. By contrast, in a case in which the customer who entered the order is outside the retail establishment, the order is processed as an invalid order. The server may inform the customer (the terminal device) who entered the order in a case in which the order has been accepted or in a case in which the order has been processed as an invalid order, or in both cases.

### APPLICATION EXAMPLE 4

A printer prints details of an order entered from a terminal device via an ordering application for receiving entry of the order. The ordering application is provided to the terminal device from a server. The printer includes a second receiver, a second transmitter, and a printing unit. The second receiver receives from the terminal device an email based on an email form to which a token for permitting access from a printer is attached. The token is transmitted to the terminal device from the server that received the entry of the order from the terminal device. The second transmitter transmits to the server an authentication request for the token attached to the email received by the second receiver. The printing unit prints the details of the order based on authentication of the token by the server.

By accessing the server, this printer can print the details of the order that is entered from the terminal device via the ordering application and that is received by the server. The access to the server from the printer can be achieved by the process described below. After receiving the entry of the order from the terminal device, the server generates a token for permitting access from the printer, and transmits to the terminal device the email form in a state in which the token is attached to the email form. The second receiver of the printer receives from the terminal device the email with the attached token in accordance with the email form transmitted from the server to the terminal device. The second transmitter of the printer transmits to the server the authentication request for the token attached to the email received from the terminal device. The printing unit prints the details of the order based on authentication of the token by the server. In this manner, the order is accepted. That is, the order can be accepted by using the printer.

### BRIEF DESCRIPTION OF THE DRAWINGS

The invention will be described with reference to the accompanying drawings, wherein like numbers reference like elements.

FIG. 1 is a schematic diagram illustrating a main configuration of an ordering system according to an embodiment of the invention.

FIG. 2 is a diagram illustrating an operational flow of the ordering system according to an embodiment of the invention.

### DESCRIPTION OF EXEMPLARY EMBODIMENTS

An embodiment of the invention will be described by using an ordering system as an example with reference to the drawings.

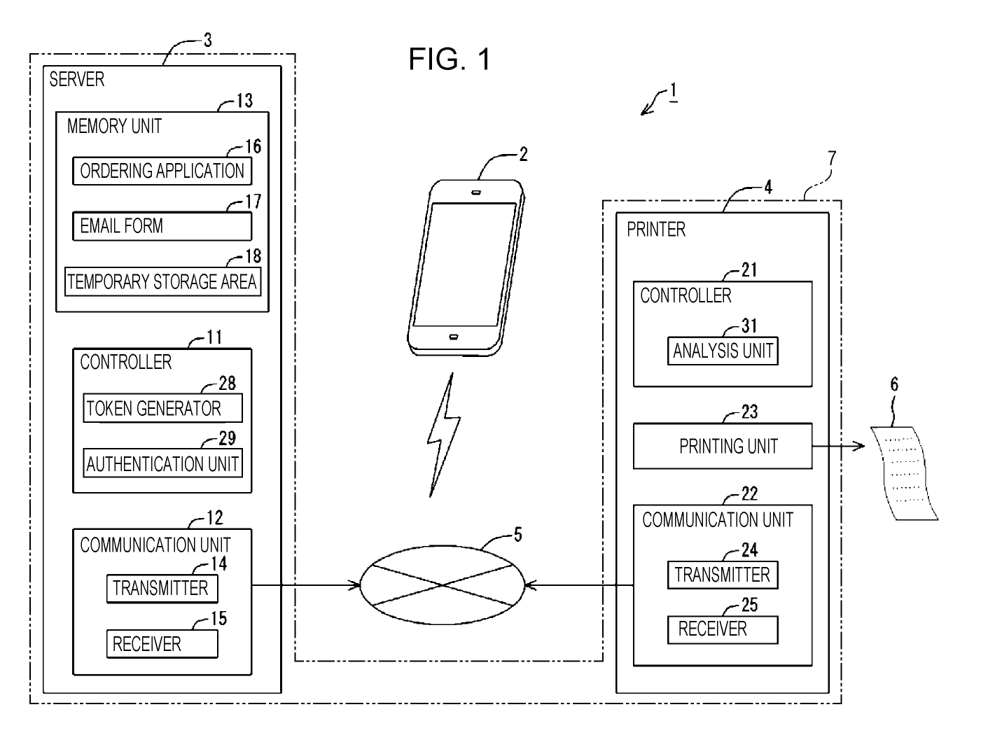

An ordering system 1 according to this embodiment includes a terminal device 2, a server 3, and a printer 4, as illustrated in FIG. 1. The terminal device 2, the server 3, and the printer 4 are configured to communicate with each other via a network 5. The network 5 may be a wired or a wireless network.

The ordering system 1 can be utilized, for example, in retail establishments such as restaurants. When a customer at a retail establishment enters an order by using the terminal device 2, which is owned by the customer, details of the order from the customer are printed out by the printer 4 located in the retail establishment. By outputting a print result 6 from the printer 4, the order from the customer is accepted. In the ordering system 1, the server 3 mediates communication (connection) between the terminal device 2 and the printer 4. In the ordering system 1, the printer 4 and the terminal device 2 are located inside the retail establishment. The server 3 can be located inside or outside the retail establishment.

In this embodiment, the terminal device 2 is possession of the customer. The customer brings their terminal device 2 to the retail establishment and enters the order by using the terminal device 2. The terminal device 2 has a function capable of transmitting and receiving emails via the network 5 and a function capable of running an application provided from the server 3 via the network 5. Examples of the application provided by the server 3 via the network 5 include a web application. Examples of the terminal device 2 include a mobile phone, a smartphone, a tablet terminal, and an Internet terminal.

The configuration of the ordering system 1 excluding the terminal device 2 is the configuration of an order receiving system 7. The order receiving system 7 has the server 3 and the printer 4 that can communicate with each other via the network 5. When the terminal device 2 participates in the order receiving system 7, the ordering system 1 is established.

The server 3 includes a controller 11, a communication unit 12, and a memory unit 13. The controller 11 includes an arithmetic device such as a central processing unit (CPU) and a program executed by the CPU. The controller 11 controls the operation of the server 3. The communication unit 12 connects to the network 5. The communication unit 12 includes a transmitter 14 that is an example of a first transmitter and a receiver 15 that is an example of a first receiver. The controller 11 causes the transmitter 14 and the receiver 15 of the communication unit 12 to transmit and receive various types of data via the network 5 to and from the terminal device 2 and the printer 4.

The memory unit 13 stores various types of application software and various types of data. A hardware resource such as memory including various types of random access memory (RAM) and various types of read-only memory (ROM), and a storage device such as a hard disk drive (HDD), for example, can be implemented as the memory unit 13. In this embodiment, application software stored in the memory unit 13 includes an ordering application 16. An example of data stored in the memory unit 13 includes an email form 17. The email form 17 includes an email address for the printer 4. The memory unit 13 has a temporary storage area 18. The temporary storage area 18 is, for example, an area to temporarily store various types of data received from the terminal device 2 and the printer 4.

The printer 4 includes a controller 21, a communication unit 22, and a printing unit 23. The controller 21 includes an arithmetic device, such as a central processing unit (CPU), and a program executed by the CPU. The controller 21 controls the operation of the printer 4. The communication unit 22 connects to the network 5. The communication unit 22 includes a transmitter 24, which is an example of a second transmitter, and a receiver 25, which is an example of a second receiver. The controller 21 causes the transmitter 24 and the receiver 25 of the communication unit 22 to transmit and receive various types of data via the network 5 to and from the terminal device 2 and the server 3. The printing unit 23 prints the details of the order entered from the terminal device 2 by the customer as the print result 6 in accordance with a command from the controller 21. The print result 6 printed by the printing unit 23 is output from the printer 4 (for example, discharged from a discharge port of the printer 4).

The operation of the ordering system 1 will be described below. For convenience of description, the description of the operation of the ordering system 1 includes the operation of the customer at the retail establishment. The operation of the ordering system 1 itself, however, does not include the operation of the customer. It should be noted that the operation of the terminal device 2 when the terminal device 2 receives the operation of the customer to operate the terminal device 2, and the operation of the terminal device 2 based on the operation of the customer are included in the operation of the ordering system 1. The operation of the order receiving system 7 does not include the operation of the customer or the operation of the terminal device 2. The operations in which the receiver 15 of the server 3 and the receiver 25 of the printer 4 receive various types of information and data transmitted from the terminal device 2 are included in the operation of the order receiving system 7.

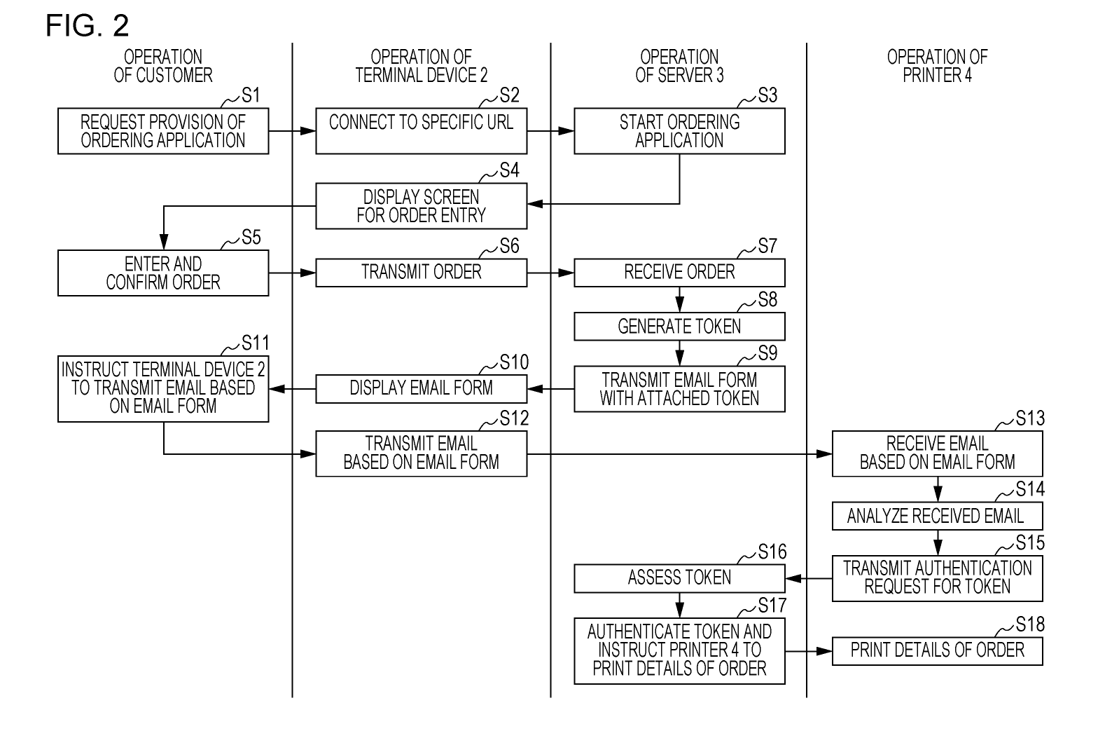

As illustrated in FIG. 2, in the operation of the ordering system 1, the customer at the retail establishment first requests provision of the ordering application 16 from the terminal device 2 at a seat where the customer will receive an order item (S1). An example of the method of requesting the provision of the ordering application 16 from the terminal device 2 is a method in which the customer inputs a specific uniform resource locator (URL) or a path to the terminal device 2 to request the provision of the ordering application 16. Examples of the method of inputting the URL or the path to the terminal device 2 are a method in which the customer manually inputs the URL or the path, and a method in which the URL or the path is input by causing the terminal device 2 to read, for example, a bar code or a two-dimensional code. The URL or the path is specified for each customer or each seat, so that the customer or the seat can be identified by the ordering application 16.

In this embodiment, the terminal device 2 accesses the specific URL to request the provision of the ordering application 16 (S2). Requesting the provision of the ordering application 16 by the terminal device 2 is the start of the operation of the ordering system 1. In this embodiment, after the URL is input to the terminal device 2, the operation of the ordering system 1 starts. When the connection to the specific URL is established in the terminal device 2, the request from the terminal device 2 to provide the ordering application 16 is accomplished.

In response to the request from the terminal device 2 to provide the ordering application 16, the controller 11 of the server 3 starts the ordering application 16 (S3). When the ordering application 16 starts, a screen for receiving entry of an order is displayed on a display of the terminal device 2 (S4). In this manner, the ordering application 16 is provided to the terminal device 2 by the server 3. That is, the server 3 provides the ordering application 16 for receiving entry of an order in response to the request from the customer.

While looking at the screen of the terminal device 2, the customer enters the order to the ordering application 16 and then confirms the order by an order confirmation processing operation (S5). The order confirmation processing operation can be performed for example by pressing a “Confirmation” button in the ordering application 16. After the order confirmation processing operation is performed, the terminal device 2 transmits the order via the ordering application 16 to the server 3 (S6).

The server 3 receives the order transmitted from the terminal device 2 (S7). To be specific, the receiver 15 of the server 3 receives the order transmitted from the terminal device 2. The server 3 that received the order generates a token (S8). The token is a code for identifying the terminal device 2 in which the order confirmation processing operation is performed. As illustrated in FIG. 1, the controller 11 of the server 3 includes a token generator 28 and an authentication unit 29. The token generated in the server 3 is generated by the token generator 28 of the controller 11. The function of the token generator 28 is implemented as a software operation by a program executed by a CPU. The authentication unit 29 assesses validity of the token in response to an authentication request for the token from the printer 4. If the token is determined to be valid, the order from the terminal device 2 is authenticated.

As illustrated in FIG. 2, the server 3 that generated the token transmits (outputs) to the terminal device 2 the email form 17 to which the token is attached (S9). To be specific, the transmitter 14 of the server 3 transmits the email form 17 to which the token is attached. As a mechanism of transmitting the email form 17, outputting the email form 17 via the ordering application 16 to the terminal device 2 or transmitting the email form 17 with an email to the terminal device 2, for example, can be adopted. After receiving the email form 17 from the server 3, the terminal device 2 displays the email form 17 (S10). While looking at the screen of the terminal device 2, the customer instructs the terminal device 2 to transmit an email based on the email form 17 (S11).

As described above, the email form 17 includes an email address for the printer 4. The instruction to transmit the email based on the email form 17 can be performed, for example, such that the customer presses a “Send” button in the ordering application 16. After the instruction to transmit the email based on the email form 17 is performed, the terminal device 2 transmits to the printer 4 the email, which is based on the email form 17, with the attached token (S12).

The printer 4 receives the email transmitted by the terminal device 2 (S13). To be specific, the receiver 25 of the printer 4 receives the email transmitted by the terminal device 2. The email that the printer 4 receives from the terminal device 2 is an email that is based on the email form 17 and that has the attached token. The printer 4 analyzes the email received from the terminal device 2 (S14). As illustrated in FIG. 1, the controller 21 of the printer 4 includes an analysis unit 31. The analysis unit 31 of the controller 21 analyzes the email received by the printer 4. The function of the analysis unit 31 is implemented as a software operation by a program executed by a CPU. As a result of the analysis unit 31 analyzing the email, if the analysis unit 31 determines that the token is attached to the email, the printer 4 transmits to the server 3 the authentication request for the token (S15), as illustrated in FIG. 2. To be specific, the transmitter 24 of the printer 4 transmits the authentication request for the token.

After receiving the authentication request for the token, the server 3 assesses the attached token and determines whether the token is valid (S16). If the server 3 determines that the token is valid, the server 3 authenticates the token and then instructs the printer 4 to print the details of the order from the customer corresponding to the token (S17). The token authentication processing operation is performed by the above-described authentication unit 29. In this embodiment, the controller 11 of the server 3 issues a unique token to each order from the customer. That is, in this embodiment, the token is valid for a one-time entry of the order from the customer.

The printer 4 prints the details of the order from the customer in response to the instruction for printing from the server 3 (S18). Specifically, the printing unit 23 of the printer 4 outputs the print result 6 on which the details of the order are printed. By outputting the print result 6, the order from the customer is received by the retail establishment. That is, by outputting the print result 6, the order from the customer is accepted by the retail establishment. According to the print result 6, the retail establishment prepares an order item such as a food, a beverage, or another product, which corresponds to the details of the order from the customer, and provides the order item to the customer.

In this embodiment, the token issued by server 3 is valid for a one-time entry of the order from the customer, and the token has a period of validity. In this case, in the process S16 for assessing the token, the controller 11 analyzes the attached token and determines whether it is the valid token and whether the token is within the period of validity. Since the token is valid for a one-time entry of the order, and has the period of validity, repeated use of the single token, use of the token beyond the period of validity, and the like may be prevented. As a result, placing an invalid order and receiving an order incorrectly due to an invalid order may be avoided. It should be noted that an invalid order includes an accidental order and a deliberate order (for example, mischief). Since the token is valid for a one-time entry of the order and has a period of validity as described above, security of the ordering system 1 may be ensured.

In the order receiving system 7 of this embodiment, the server 3 receives the order entered (via the ordering application 16) from the terminal device 2 owned by the customer at the retail establishment, and then the printer 4 located in the retail establishment can print the details of the order by accessing the server 3. Access to the server 3 from the printer 4 can be achieved by the process described below. First, the terminal device 2 transmits to the printer 4 the email with the attached token based on the email form 17 received from the server 3. After receiving the email with the attached token, the printer 4 transmits to the server 3 the authentication request for the token. When the server 3 receives the authentication request for the token from the printer 4 and authenticates the token, access to the server 3 from the printer 4 is permitted, and the printer 4 prints and outputs the details of the order from the customer. As a result, the order from the customer is accepted. Since the order receiving system 7 can use the terminal device 2 owned by the customer, convenience of order receiving systems may be improved by using the order receiving system 7.

The printer 4 of this embodiment can print details of the order, which is entered (via the ordering application 16) to the server 3 from the terminal device 2 owned by the customer at the retail establishment by accessing the server 3. Access to the server 3 from the printer 4 can be achieved by the process below. First, the customer who entered the order by using the terminal device 2 transmits, to the printer 4, the email, which is based on the email form 17 received from the server 3 and which has the attached token. After receiving the email with the attached token, the printer 4 transmits to the server 3 the authentication request for the token. When the server 3 that received the token from the printer 4 authenticates the token, access to the server 3 from the printer 4 is permitted, and the printer 4 prints and outputs the details of the order from the customer. As a result, the order from the customer is accepted. Since the printer 4 can use the terminal device 2 owned by the customer to receive the order from the customer, the convenience of receiving an order may be increased.

As described above, since the ordering system 1 and the order receiving system 7 can use the terminal device 2 owned by the customer at the retail establishment, the cost of investment and the cost of maintenance for the ordering system 1 and the order receiving system 7 may be reduced. Such a cost saving may be used toward further investment in customer service. Therefore, by using the ordering system 1 and the order receiving system 7, convenience may be improved for both retail establishments and their customers.

In addition, in the above-described ordering system 1, in a case in which the terminal device 2 has a global positioning system (GPS) function, GPS information (location information) may be attached in the process S6 of transmitting the order to the server 3 from the terminal device 2. In this manner, the location of the terminal device 2 transmitting the order (the location of the customer who owns the terminal device 2) can be identified. As a result, since it can be determined whether the customer who entered the order is inside the retail establishment, an invalid order from outside the retail establishment may be prevented. Thus, security of the ordering system 1 may be ensured. That is, the server 3 includes a determination unit (not shown) for determining whether the order is valid in accordance with the location of the customer (the terminal device 2) who entered the order, and only the valid order can be accepted. For example, in a case in which the customer who entered the order is inside the retail establishment, the order is accepted as a valid order. In contrast, in a case in which the customer who entered the order is outside the retail establishment, the order is processed as an invalid order. In these cases, the server 3 may inform the customer (the terminal device 2) who entered the order in a case in which the order has been accepted or in a case in which the order has been processed as an invalid order, or in both cases. The location information of the terminal device 2 may be obtained by the server 3 from the terminal device 2 after the server 3 receives the entry of the order.

In the above-described embodiment, the ordering system 1 for performing a process of placing an order of a customer at a retail establishment and accepting the order at the retail establishment is described as an example. However, examples of the system of the invention are not limited to the ordering system 1. The system of the invention, for example, may be implemented as a reservation system for making a reservation for a customer who plans to visit a retail establishment.

Furthermore, in the above-described embodiment, a web application is implemented as the ordering application 16. However, the ordering application 16 is not limited to a web application. Various types of application such as a cloud application and a stand-alone application can be implemented as the ordering application 16.

The entire disclosure of Japanese Patent Application No. 2016-239104, filed Dec. 9, 2016 is expressly incorporated by reference herein.

What is claimed is:

1. An order receiving system, comprising:
a server that provides a terminal device owned by a customer with an ordering application for receiving entry of an order, in response to a request from the customer; and
a printer that prints details of the order entered via the ordering application provided to the terminal device,
wherein the server includes
a memory unit that has an area to store the ordering application,
a first receiver that receives the entry of the order from the customer via the ordering application,
a token generator that generates a token for permitting access from the printer, and
a first transmitter that transmits to the terminal device an email form addressed to the printer in a state in which the token is attached to the email form, and
wherein the printer includes
a second receiver that receives an email from the terminal device,
a second transmitter that transmits to the server an authentication request for the token attached to the email received by the second receiver, and
a printing unit that prints the details of the order based on authentication of the token by the server.

2. The order receiving system according to claim 1, wherein
the token is valid for a one-time entry of the order from the customer received by the server, and has a period of validity.

3. The order receiving system according to claim 1, wherein
the server further includes a determination unit that determines whether the entry of the order received by the first receiver is valid in accordance with location information, the location information being transmitted from the terminal device and received by the first receiver.

4. A printer that prints details of an order entered from a terminal device via an ordering application for receiving entry of the order, the ordering application being provided from a server to the terminal device, the printer comprising:
a second receiver that receives from the terminal device an email based on an email form to which a token for permitting access from the printer is attached, the email form being transmitted to the terminal device from the server that receives the entry of the order from the terminal device;
a second transmitter that transmits to the server an authentication request for the token attached to the email received by the second receiver; and
a printing unit that prints the details of the order based on authentication of the token by the server.
